(19) United States
(12) Patent Application Publication
(10) Pub. No.: US 2012/0328182 A1
(43) Pub. Date: Dec. 27, 2012

(54) IMAGE FORMAT DISCRIMINATION DEVICE, METHOD OF DISCRIMINATING IMAGE FORMAT, IMAGE REPRODUCING DEVICE AND ELECTRONIC APPARATUS

(75) Inventors: Ikuo Tsukagoshi, Tokyo (JP); Katsunori Hashimoto, Tokyo (JP)

(73) Assignee: Sony Corporation, Tokyo (JP)

(21) Appl. No.: 13/494,330

(22) Filed: Jun. 12, 2012

(30) Foreign Application Priority Data
Jun. 21, 2011 (JP) 2011-137854

(51) Int. Cl. G06K 9/46

(52) U.S. Cl. 382/154

(57) ABSTRACT

An image format discrimination device includes a correlation candidate extraction unit that obtains a gradient amount of each pixel position, based on pixel data of a horizontal line of input image data and extracts as a correlation candidate, a pixel of a position where a sign of the gradient amount is changed; a correlation inspection unit that inspects whether or not a first correlation candidate range and a second correlation candidate range having correlation to each other in the horizontal line are present, based on the correlation candidate that is extracted by the correlation candidate extraction unit; and a discriminating image format unit that discriminates whether or not the input image data are three-dimensional image data of a side-by-side type, based on the inspection result of the correlation inspection unit.

### BACKGROUND

The present disclosure relates to an image format discrimination device, a method of discriminating an image format, an image reproducing device and an electronic apparatus. Specifically, the present disclosure relates to an image format discrimination device, a method of discriminating an image format, an image reproducing device and an electronic apparatus that discriminates whether or not input image data are three-dimensional image data of a side-by-side type.

Assuming a case where, for example, content such as a television program is transmitted to a television receiver of a user from a broadcasting station, it is considered that three-dimensional (3D) image data is transmitted as image data. As an image format of the three-dimensional image data there is a side-by-side type. The side-by-side type is for example, a type where pixel data of left eye image data is transmitted at a first half in the horizontal direction and pixel data of right eye image data is transmitted at a second half in the horizontal direction.

The television receiver may perform appropriate processing with respect to the received image data and may display a good image by ascertaining the image format of the received image data. In a case where a signal (signaling signal) that indicates the image format is added to the received image data, it does not matter, however in a case where the signal is not added thereto, the image format of the received image data is necessary to be discriminated on the basis of the received image data.

For example, a method of discriminating three-dimensional image data of a side-by-side type based on the image data is disclosed in Japanese Unexamined Patent Application Publication No. 2010-068315. In the discriminating method, the discrimination is performed using correlation between left and right rectangular focus portion areas.

### SUMMARY

It is desirable to preferably perform discrimination of three-dimensional image data of a side-by-side type.

According to an embodiment of the present disclosure, there is provided an image format discrimination device including: a correlation candidate extraction unit that obtains a gradient amount of each pixel position based on pixel data of a horizontal line of input image data, and extracts, as a correlation candidate, a pixel of a position where a sign of the gradient amount is changed; a correlation inspection unit that inspects whether or not a first correlation candidate range and a second correlation candidate range having correlation to each other in the horizontal line are present, based on the correlation candidate that is extracted by the correlation candidate extraction unit; and a discriminating image format unit that discriminates whether or not the input image data are three-dimensional image data of a side-by-side type, based on the inspection result of the correlation inspection unit.

In the embodiment of the present disclosure, the correlation candidate extraction unit obtains the gradient amount of each pixel position based on the pixel data of the horizontal line of the input image data and extracts, as the correlation candidate, the pixel of the position where the sign of the gradient amount is changed. In this case, for example, the correlation candidate extraction unit may obtain the differential of the pixel data values between adjacent pixels as the gradient amount of each pixel position.

The correlation inspection unit inspects whether or not the first correlation candidate range and the second correlation candidate range having the correlation to each other in the horizontal line are present, based on the correlation candidate that is extracted at the correlation candidate extraction unit. In a case of the three-dimensional image data of the side-by-side type, the left eye image and the right eye image are arranged side-by-side in the horizontal direction. Thus, in a case of the three-dimensional image data of the side-by-side type, the presence of the first correlation candidate range and the second correlation candidate range are detected.

Thus, the discriminating image format unit discriminates whether or not the input image data are the three-dimensional image data of the side-by-side type, based on the inspection result of the correlation detection unit. In this case, when the first correlation candidate range and the second correlation candidate range having the correlation to each other in the horizontal line are present, the input image data are identified as three-dimensional image data of the side-by-side type.

As described above, in the embodiment of the present disclosure, the pixel of the position where the sign of the gradient amount of the pixel data of the horizontal line is changed is extracted as the correlation candidate. The input image data are identified as three-dimensional image data of the side-by-side type according to whether or not the first correlation candidate range and the second correlation candidate range having the correlation to each other in the horizontal line are present. Thus, the discrimination of the three-dimensional image data of the side-by-side type may be appropriately performed.

In addition, in the embodiment of the present disclosure, for example, the discriminating image format unit may obtain a border pixel position of a left eye image and a right eye image in the horizontal direction, based on a size ratio of the first correlation candidate range and the second correlation candidate range when it is discriminated that the input image data are the image data of the side-by-side type. Thus, the border pixel position (the L/R border coordinate) is obtained so that even in a case where resolutions in the horizontal direction of the left eye image data and the right eye image data are different, the cut out of the left eye image data or the right eye image data from the input image data may be appropriately performed.

In addition, in the embodiment of the present disclosure, for example, the discriminating image format unit may discriminate whether or not the input image data are the three-dimensional image data of the side-by-side type, based on the inspection result of a plurality of horizontal lines in the correlation inspection unit. Thus, discrimination precision of whether or not the image data of the side-by-side type are present may be increased. In addition, precision of the border pixel position of the left eye image and the right eye image in the horizontal direction may also be increased.

In addition, according to another embodiment of the present disclosure there is provided an image reproducing device including: an image format discrimination device that discriminates whether or not input image data are three-dimensional image data of a side-by-side type, based on the input image data; and an image data processing unit that processes the input image data based on the discrimination result of the image data discrimination device and obtains an image data for display, wherein the image format discrimination device includes, a correlation candidate extraction unit that obtains a gradient amount of each pixel position, based on pixel data of a horizontal line of the input image data and extracts, as a correlation candidate, a pixel of a position where a sign of the gradient amount is changed; a correlation inspection unit that inspects whether or not a first correlation candidate range and a second correlation candidate range having the correlation to each other in the horizontal line, based on the correlation candidate that is extracted by the correlation candidate extraction unit; and a discriminating image format unit that discriminates whether or not the input image data are the three-dimensional image data of the side-by-side type, based on the inspection result of the correlation inspection unit.

In the embodiment of the present disclosure, the image format discrimination device discriminates whether or not the input image data are the three-dimensional image data of the side-by-side type, based on the input image data. Thus, the image data processing unit processes the input image data based on the discrimination result of the image format discrimination device and generates the image data for display.

The image format discrimination device includes the correlation candidate extraction unit, the correlation inspection unit and the discriminating image format unit, and the discrimination of the three-dimensional image data of the side-by-side type is appropriately performed. Thus, in the embodiment of the present disclosure, the image data processing unit may appropriately perform the process with respect to the input image data and preferably performs the generation of the image data for display.

In addition, according to still another embodiment of the present disclosure is an image reproducing device including: an image format discrimination device that discriminates whether or not input image data are three-dimensional image data of a side-by-side type, based on the input image data and, when it is discriminated that the input data are the three-dimensional image data of the side-by-side type, obtains a border pixel position of a left eye image and a right eye image in a horizontal direction; and an image data processing unit that cuts out left eye image data and right eye image data, based on the border pixel position that is obtained by the image format discrimination device from the input image data, performs a scaling process in the horizontal direction and generates image data for display of the left eye and the right eye when the image format discrimination device discriminates that the input data are the three-dimensional image data of the side-by-side type, wherein the image format discrimination device includes a correlation candidate extraction unit that obtains a gradient amount of each pixel position, based on pixel data of a horizontal line of the input image data and extracts as the correlation candidate, a pixel of a position where a sign of the gradient amount is changed; a correlation inspection unit that inspects whether or not a first correlation candidate range and a second correlation candidate range having the correlation to each other in the horizontal line are present, based on the correlation candidate that is extracted by the correlation candidate extraction unit; and a discriminating image format unit that discriminates whether or not the input image data are three-dimensional image data of the side-by-side type, based on the inspection result of the correlation inspection unit and, when it is discriminated that the input data are the image data of the side-by-side type, obtains the border pixel position of the left eye image and the right eye image in the horizontal direction, based on size ratio of the first correlation candidate range and the second correlation candidate range.

In the embodiment of the present disclosure, the image format discrimination device discriminates whether or not the input image data are the three-dimensional image data of the side-by-side type based on the input image data and when it is discriminated that the input data are the three-dimensional image data of the side-by-side type, obtains the border pixel position of the left eye image and the right eye image in the horizontal direction. Thus, the image data processing unit cuts out the left eye image data and the right eye image data based on the border pixel position, performs the scaling process in the horizontal direction and generates the image data for display of the left eye and the right eye, when the image format discrimination device discriminates that the input data are the three-dimensional image data of the side-by-side type.

The image format discrimination device includes the correlation candidate extraction unit, the correlation inspection unit and the discriminating image format unit, and preferably performs the discrimination of the three-dimensional image data of the side-by-side type. In addition, the border pixel position of the left eye image and the right eye image is also preferably obtained. Thus, in the embodiment of the present disclosure, the image data processing unit appropriately performs the process with respect to the input image data and then preferably performs the generation of the image data for display of the left eye and the right eye.

In addition, in the embodiment of the present disclosure, for example, the image data processing unit may cut out the left eye image data and the right eye image data, performs scaling process in the horizontal direction and generates image data for display of the left eye and the right eye, when the discriminating image format unit discriminates that the input data are the three-dimensional image data of the side-by-side type in the three-dimensional display mode, based on the border pixel position that is obtained by the discriminating image format unit from the input image data, and wherein the image data processing unit cuts out the left eye image data and the right eye image data, performs scaling process in the horizontal direction and generates image data for two-dimensional display, when the discriminating image format unit discriminates that the input data are the three-dimensional image data of the side-by-side type in the two-dimensional display mode, based on the border pixel position that is obtained by the discriminating image format unit from the input image data. In this case, even in the three-dimensional display mode, and even in the two-dimensional display mode, the generation of the image data for display is preferably performed.

In addition, according to still another embodiment of the present disclosure there is provided an image reproducing device including: an image format discrimination device that discriminates whether or not input image data are three-dimensional image data of a side-by-side type, based on the input image data and, when it is discriminated that the input data are the three-dimensional image data of the side-by-side type, obtains a border pixel position of a left eye image and a right eye image in a horizontal direction; and an image data processing unit that cuts out left eye image data and right eye image data, based on the border pixel position that is obtained by the discriminating image format unit from the input image data, performs a scaling process in the horizontal direction and generates image data for two-dimensional display, when the image format discrimination device discriminates that the input data are the three-dimensional image data of the side-by-side type, wherein the image format discrimination device includes, a correlation candidate extraction unit that obtains a gradient amount of each pixel position, based on pixel data of a horizontal line of the input image data and extracts as the correlation candidate, a pixel of a position where a sign of the gradient amount is changed, a correlation inspection unit that inspects whether or not a first correlation candidate range and a second correlation candidate range having the correlation to each other in the horizontal line are present, based on the correlation candidate that is extracted by the correlation candidate extraction unit; and a discriminating image format unit that discriminates whether or not the input image data are the three-dimensional image data of the side-by-side type, based on the inspection result of the correlation inspection unit and, when it is discriminated that the input data are the image data of the side-by-side type, obtains the border pixel position of the left eye image and the right eye image in the horizontal direction, based on size ratio of the first correlation candidate range and the second correlation candidate range.

In the embodiment of the present disclosure, the image format discrimination device discriminates whether or not input image data are three-dimensional image data of a side-by-side type based on the input image data and when it is discriminated that the input data are the three-dimensional image data of the side-by-side type, obtains a border pixel position of a left eye image and a right eye image. Thus, the image data processing unit cuts out the left eye image data or the right eye image data, performs the scaling process in the horizontal direction and generates the image data for two-dimensional display when the image format discrimination device discriminates that the input data are the three-dimensional image data of the side-by-side type.

The image format discrimination device includes the correlation candidate extraction unit, the correlation inspection unit and the discriminating image format unit, and preferably performs the discrimination of the three-dimensional image data of the side-by-side type. In addition, the border pixel position of the left eye image and the right eye image is also preferably obtained. Thus, in the embodiment of the present disclosure, the image data processing unit appropriately performs the process with respect to the input image data and then preferably performs the generation of the image data for two-dimensional display.

In addition, according to still another embodiment of the present disclosure is an electronic apparatus including: an image format discrimination device that discriminates an image format of input image data, wherein the image format discrimination device includes, a correlation candidate extraction unit that obtains a gradient amount of each pixel position, based on pixel data of a horizontal line of the input image data and extracts as a correlation candidate, a pixel of a position wherein a sign of the gradient amount is changed; a correlation inspection unit that inspects whether or not a first correlation candidate range and a second correlation candidate range having the correlation to each other in the horizontal line are present, based on the correlation candidate that is extracted by the correlation candidate extraction unit; and a discriminating image format unit that discriminates whether or not the input image data are three-dimensional image data of a side-by-side type, based on the inspection result of the correlation inspection unit.

The electronic apparatus of the present disclosure includes the image format discrimination device that discriminates the image format of the input image data. Here, the electronic apparatus corresponds to a television receiver, a recorder and a player or the like. The image format discrimination device includes the correlation candidate extraction unit, the correlation inspection unit and the discriminating image format unit. Thus the discrimination of the three-dimensional image data of the side-by-side type may be preferably performed. The discrimination result may be used inside the electronic apparatus or may be supplied to external equipment with the image data from the electronic apparatus.

According to the embodiments of the present disclosure, the discrimination of the three-dimensional image data of the side-by-side type may be preferably performed.

### BRIEF DESCRIPTION OF THE DRAWINGS

FIG. 1 is a block diagram illustrating a configuration example of a television receiver of a first embodiment of the present disclosure.

FIGS. 2A to 2F are views explaining a process based on discriminating image format information in 3D signal processing unit that configures the television receiver.

FIG. 3 is a block diagram illustrating a configuration example of an image format discrimination device that configures the television receiver.

FIG. 4 is a view illustrating an example of a correlation candidate that is extracted using a correlation candidate extraction unit of an image format discrimination device.

FIG. 5 is a view illustrating an example of a correlation candidate that is extracted using a correlation candidate extraction unit of an image format discrimination device in a case where an image data is three-dimensional image data of a side-by-side type.

FIG. 6 is a view illustrating embodied example of a correlation inspection in a correlation inspection unit of an image format discrimination device.

FIG. 7 is a view illustrating a relation among a correlation candidate, scan•target value ST, a coincidence list and an accord list in an embodied example of a correlation inspection in a correlation inspection unit.

FIG. 8 is a view explaining that final border pixel position is determined based on a border pixel position obtained at each horizontal line.

FIG. 9 is a view illustrating that a border position of a left eye image and a right eye image in the horizontal direction is correctly obtained, even when a horizontal sizes of the left eye image and the right eye image are different.

FIG. 10 is a flowchart (1/2) illustrating an example of a process sequence of an image format discrimination device.

FIG. 11 is a flowchart (2/2) illustrating an example of a process sequence of an image format discrimination device.

FIG. 12 is a block diagram illustrating a configuration example of a television receiver of a second embodiment of the present disclosure.

### DETAILED DESCRIPTION OF EMBODIMENTS

Hereinafter, forms of the present disclosure (below, referred to as embodiments) will be described. In addition, the description will be given in the order below.

1. First embodiment

2. Second embodiment

3. Modification example

### 1. First Embodiment

[Configuration Example of Television Receiver (3DTV)]

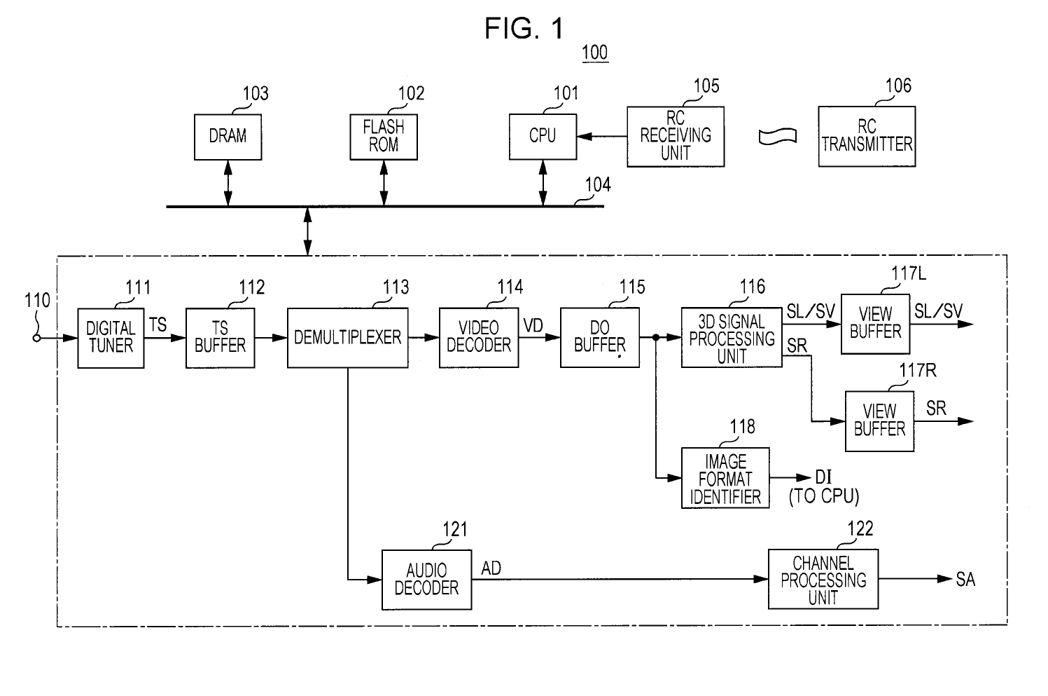

FIG. 1 is configuration example of a television receiver 100 of a first embodiment of the present disclosure. The television receiver 100 is a television receiver (3DTV) that may 3D display. The television receiver 100 has a CPU 101, a flash ROM 102, a DRAM 103, an internal bus 104, a remote control receiver (a RC receiver) 105 and a remote control transmitter (a RC transmitter) 106.

In addition, the television receiver 100 has an antenna terminal 110, a digital tuner 111, a transport stream buffer (a TS buffer) 112 and a demultiplexer 113. In addition, the television receiver 100 has a video decoder 114, a display output buffer (a DO buffer) 115, a 3D signal processing unit 116, view buffers 117L and 117R and an image format discrimination device 118. Furthermore, the television receiver 100 has an audio decoder 121 and a channel processing unit 122.

The CPU 101 controls an operation of each unit of the television receiver 100. The flash ROM 102 performs storage of control software and storage of data. The DRAM 103 configures a work area of the CPU 101. The CPU 101 develops the software or data that readout from the flash ROM 102 on the DRAM 103, starts the software and controls each unit of the television receiver 100.

The RC receiver 105 receives a remote control signal (a remote control code) that is transmitted from the RC transmitter 106 and supplies the remote control signal to the CPU 101. The CPU 101 controls each unit of the television receiver 100, based on the remote control code. The CPU 101, the flash ROM 102 and the DRAM 103 are connected to the internal bus 104 respectively.

The antenna terminal 110 is a terminal that inputs a television broadcasting signal received at a receiving antenna (not shown). The digital tuner 111 processes the television broadcasting signal input in the antenna terminal 110 and outputs a predetermined transport stream TS corresponding to a channel that is selected by a user. The TS buffer 112 temporarily accumulates the transport stream TS that is output from the digital tuner 111.

A video elementary stream and an audio elementary stream are multiplexed and included in the transport stream TS. A three-dimensional (3D) image data of a side-by-side type or two-dimensional (2D) image data are inserted in the video elementary stream.

The demultiplexer 113 extracts the video elementary stream and the audio elementary stream from the transport stream TS that is temporarily accumulated in the TS buffer 112. The video decoder 114 performs a decoding process with respect to coded image data included in the video elementary stream that is extracted at the demultiplexer 113 so as to obtain image data VD thereof. The image data VD is two-dimensional image data or the three-dimensional image data of the side-by-side type. The DO buffer 115 temporarily accumulates the image data obtained by the video decoder 114.

When the image data VD that is accumulated at the DO buffer 115 is three-dimensional image data of the side-by-side type, the 3D signal processing unit 116 performs below process. In other words, in a case where three-dimensional display mode is selected, left eye image data and right eye image data are cut out from the image data VD, scanning process in the horizontal direction is performed, and image data SL for left eye display and image data SR for right eye display are generated. In addition, in a case where the two-dimensional display mode is selected, the left eye image data or right eye image data are cut out from the image data VD, the scanning process in the horizontal direction is performed and image data SV for two-dimensional display is generated.

First, when the image data VD that is accumulated in the DO buffer 115 is the two-dimensional image data, the 3D signal processing unit 116 performs below process irrelevant that the three-dimensional display mode is selected or the two-dimensional display mode is selected. In other words, the 3D signal processing unit 116 outputs the image data VD as is, as image data SV for two-dimensional display.

The view buffer 117L temporarily accumulates the image data SL for left eye display that is obtained by the 3D signal processing unit 116 or the image data SV for two-dimensional display that is generated at the 3D signal processing unit 116, and outputs to an image output unit such as display. In addition, the view buffer 117R temporarily accumulates the image data SR for right eye display that is obtained the 3D signal processing unit 116 and outputs to the image output unit such as display.

The image format discrimination device 118 discriminates the image format of the image data VD that is accumulated in the DO buffer 115. In other words, the image format discrimination device 118 discriminates whether or not the image data VD is the three-dimensional image data of side-by-side type or the two-dimensional image data, based on the image data VD. In addition, when the image data VD is identified as the three-dimensional image data of side-by-side type, the image format discrimination device 118 further obtains a border pixel position (a L/R border coordinate) of the left eye image and the right eye image in the horizontal direction.

The image format discrimination device 118 obtains a gradient amount of each pixel position and extracts the pixel of a position where a sign of the gradient amount is changed as a correlation candidate, based on the pixel data of a horizontal line of the image data VD. Thus, the image format discrimination device 118 inspects whether or not the first correlation candidate range and the second correlation candidate range having the correlation to each other on the horizontal line is present, based on the correlation candidate.

Thus, the image format discrimination device 118 discriminates whether the image data VD is the three-dimensional image data of the side-by-side type or the two-dimensional image data, based on the inspection result. In a case where the first correlation candidate range and the second correlation candidate range having the correlation to each other in the horizontal line are present, the image format discrimination device 118 discriminates that the image data VD is the three-dimensional image data of the side-by-side type. Meanwhile, in a case where the first correlation candidate range and the second correlation candidate range having the correlation to each other in the horizontal line are not present, the image format discrimination device 118 discriminates that the image data VD is the two-dimensional image data.

In addition, when the image format discrimination device 118 discriminates that the image data VD is the three-dimensional image data of the side-by-side type, the image format discrimination device 118 further obtains the border pixel position (the L/R border coordinates) of the left eye image and the right eye image in the horizontal direction. In this case, the image format discrimination device 118 obtains the border pixel position (the L/R border coordinates), based on a size ratio of the first correlation candidate range and the second correlation candidate range.

The image format discrimination device 118 transmits discrimination information DI that indicates the discrimination result of the image format to the CPU 101. As described above, in a case where the image data VD is the three-dimensional image data of the side-by-side type and the border pixel position of the left eye image and the right eye image in the horizontal direction is obtained, the information is also included in the discrimination information DI. The CPU 101 realizes the image format or the like of the image data VD and controls so as to operate the 3D signal processing unit 116, the view buffers 117L and 117R, the image output unit or the like according to the image format, based on the discrimination information DI. A detailed description of the image format discrimination device 118 will be given below.

The audio decoder 121 obtains voice data AD that are decoded by performing a decoding process with respect to encoded voice data that are included in the audio elementary stream extracted in the demultiplexer 113. The channel processing unit 122 generates voice data SA of each channel in order to realize for example, 5.1 channel surround sound with respect to the voice data AD obtained by the audio decoder 121 and outputs to a voice output unit (not shown).

Operation of the television receiver 100 shown in FIG. 1 will be briefly described. The television broadcasting signal that is input to the antenna terminal 110 is supplied to the digital tuner 111. The television broadcasting signal is processed in the digital tuner 111 so that a predetermined transport stream TS that is corresponding to the channel that is selected by the user is output. The transport stream TS is temporarily accumulated in the TS buffer 112.

The demultiplexer 113 extracts each elementary stream of the video and audio from the transport stream TS that is temporarily accumulated in the TS buffer 112. The video elementary stream that is extracted in the demultiplexer 113 is supplied to the video decoder 114.

The video decoder 114 performs the decoding process with respect to the encoded image data that is included in the video elementary stream extracted at the demultiplexer 113 and then obtains the image data (the two-dimensional image data or the three-dimensional image data of the side-by-side type) VD. The image data VD is temporarily accumulated in the DO buffer 115.

The image format discrimination device 118 discriminates whether or not the image data VD is the three-dimensional image data of the side-by-side type or the two-dimensional image data, based on the image data VD. In addition, when three-dimensional image data of the side-by-side type is identified, the image format discrimination device 118 further obtains the border pixel position of the left eye image and the right eye image in the horizontal direction.

The discrimination information DI indicating the discrimination result of the image format is transmitted to the CPU 101 from the image format discrimination device 118. The CPU 101 discriminates the image format of the image data VD that is accumulated in the DO buffer 115, which is obtained by the video decoder 114, based on the discrimination information DI. In addition, in a case where the image data VD is the three-dimensional image data of the side-by-side type, the CPU 101 discriminates the border pixel position of the left eye image and the right eye image in the horizontal direction. Thus, the 3D signal processing unit 116, the view buffers 117L and 117R, the image output unit or the like are controlled by the CPU 101 so as to operate according to the image format.

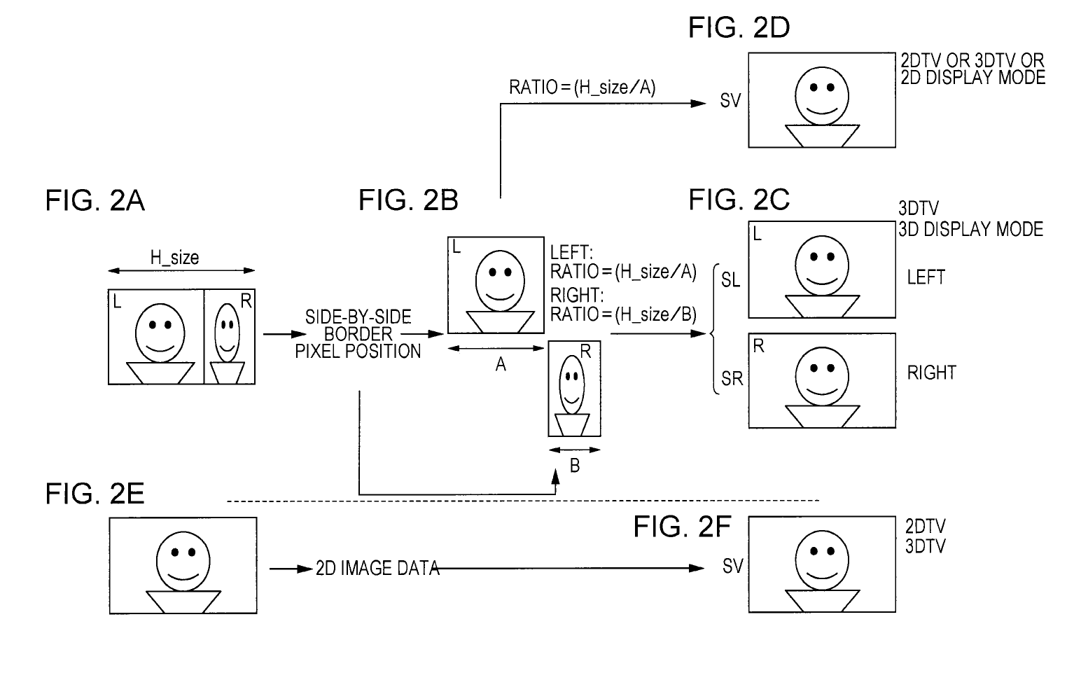

As shown in FIG. 2A, when the image data VD is the three-dimensional image data of the side-by-side type, the image format discrimination device 118 discriminates that the image data VD is the three-dimensional image data of the side-by-side type. At this time, the image format discrimination device 118 further obtains the border pixel position (the L/R border coordinate) of the left eye image and the right eye image in the horizontal direction. At this time, in a case where the three-dimensional (3D) display mode is selected, each unit such as the 3D signal processing unit 116 becomes in a state where a three-dimensional image process is performed. Meanwhile, in a case where the two-dimensional (2D) display mode is selected, a two-dimensional image process is performed.

Description regarding the three-dimensional image process when the image data VD is the three-dimensional image data of the side-by-side type will be given. In this case, as shown in FIG. 2B, the 3D signal processing unit 116 cuts out the left eye image data and the right eye image data from the image data VD that is accumulated in the DO buffer 115, based on the border pixel position of the left eye image and the right eye image in the horizontal direction.

Accordingly, the 3D signal processing unit 116 performs a scanning process in the horizontal direction with respect to the left eye image data and the right eye image data that are cut out, and as shown in FIG. 2C, the image data SL for left eye display and the image data SR for right eye display are generated. Here, in a case where a horizontal size of the left eye image is “A” with respect to a horizontal size H_size of the entire image, a scanning process where the size becomes H_size/A times in the horizontal direction with respect to the left eye image data is performed. Similarly, in a case where a horizontal size of the right eye image is “B” with respect to the horizontal size H_size of the entire image, a scanning process where the size becomes H_size/B times in the horizontal direction with respect to the right eye image data are performed.

The image data SL and SR for display that are generated in the 3D signal processing unit 116 are supplied to the image output unit such as display through the view buffers 117L and 117R. The image output unit performs the image display where the user perceives the three-dimensional image, based on the image data SL and SR for display. For example, in a shutter glasses type, the left eye image and the right eye image are displayed alternatively synchronized with for example, a shutter operation of a shutter glasses.

Next, description regarding the two-dimensional image process will be give when the image data VD is the three-dimensional image data of the side-by-side type. In this case, the 3D signal processing unit 116 cuts out image data one of the left eye image data and the right eye image data shown in FIG. 2B from the image data VD that is accumulated in the DO buffer 115. In this case, the 3D signal processing unit 116 cuts out the image data, based on the border pixel position of the left eye image and the right eye image in the horizontal direction. In this case, for example, the cut out of the image data that is large in the horizontal size among the left eye image data and the right eye image data, the cut out of the left eye image data is performed in the example of FIGS. 2A to 2F.

Accordingly, the 3D signal processing unit 116 performs the scaling process in the horizontal direction with respect to, for example, the left eye image data that is cut out and as shown in FIG. 2D, the image data SV for two-dimensional display is generated. Here, in a case where the horizontal size of the left eye image is “A” with respect to the horizontal size H_size of the entire image, the scaling process where the size becomes H_size/A times in the horizontal direction with respect to the left eye image data is performed.

The image data SV for two-dimensional display that is generated in the 3D signal processing unit 116 is supplied to the image output unit such as the display through the view buffer 117L. The image output unit displays the two-dimensional image, based on the image data SV for two-dimensional display.

As shown in FIG. 2E, when the image data VD is the two-dimensional image data, the image format discrimination device 118 discriminates that the image data VD is the two-dimensional image data. At this time, even though any one of the three-dimensional display mode and the two-dimensional display mode is selected, each unit such as the 3D signal processing unit 116 becomes in a state that the two-dimensional image process is performed.

In this case, as shown in FIG. 2F, the 3D signal processing unit 116 outputs the image data VD as is, that is accumulated in the DO buffer 115 as the image data SV for two-dimensional display. The image data SV for two-dimensional display is supplied to the image output unit such as display through the view buffer 117L. The two-dimensional image is displayed on the image output unit, based on the image data SV for two-dimensional display.

In addition, the audio elementary stream that is extracted in the demultiplexer 113 is supplied to the audio decoder 121. The audio decoder 121 performs the decoding process with respect to the coded voice data that is included in the audio elementary stream so that the voice data AD that is decoded is obtained. The voice data AD is supplied to the channel processing unit 122. The channel processing unit 122 generates the voice data SA of each channel to realize for example, 5.1 channel surround sound or the like with respect to the voice data. The voice data SA are supplied to the voice output unit such as a speaker and the voice corresponding to the display image is output.

As described above, in the television receiver (3DTV) 100 shown in FIG. 1, the discrimination information DI of the image format discrimination device 118 is used so that good image display is performed. In other words, when the received image data VD is the three-dimensional image data of the side-by-side type, in a case where the three-dimensional display mode is selected, the cut out of the left eye image data and the right eye image data is appropriately performed so that the display of the three-dimensional image is favorably performed.

In addition, when the image data VD is the three-dimensional image data of the side-by-side type, in a case where the two-dimensional display mode is selected, the cut out of the left eye image data or the right eye image data are favorably performed so that the display of the two-dimensional image is favorably performed. Furthermore, when the received image data VD is the two-dimensional image data, the display of the two-dimensional image is favorably performed by two-dimensional image data.

[Configuration Example of Image Format Discrimination Device]

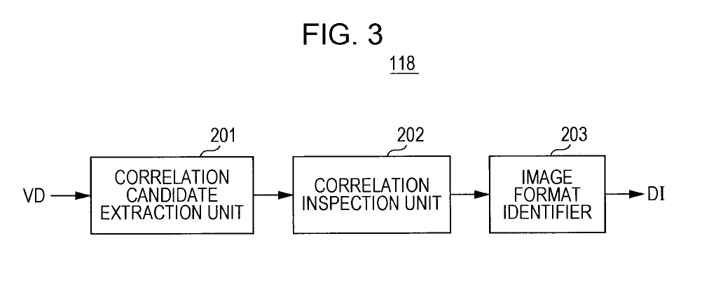

The image format discrimination device 118 will be described detail. FIG. 3 shows a configuration example of the image format discrimination device 118. The image format discrimination device 118 has a correlation candidate extraction unit 201, a correlation inspection unit 202 and a discriminating image format unit 203.

The correlation candidate extraction unit 201 obtains the gradient amount of each pixel position and extracts as the correlation candidate, the pixel of the position where the sign of the gradient amount is changed, based on the pixel data of the horizontal line of the image data VD. A derivative process with respect to the pixel data of the horizontal line is performed so that the gradient amount of each pixel may be obtained. In the embodiment, the correlation candidate extraction unit 201 obtains as the gradient amount of each pixel, a differential of the pixel data value between adjacent pixels, in other words, Lx+1−Lx. Here, Lx is the pixel data value of an object pixel Px, Lx+1 is the pixel data value of the pixel Px+1 adjacent to the object pixel Px.

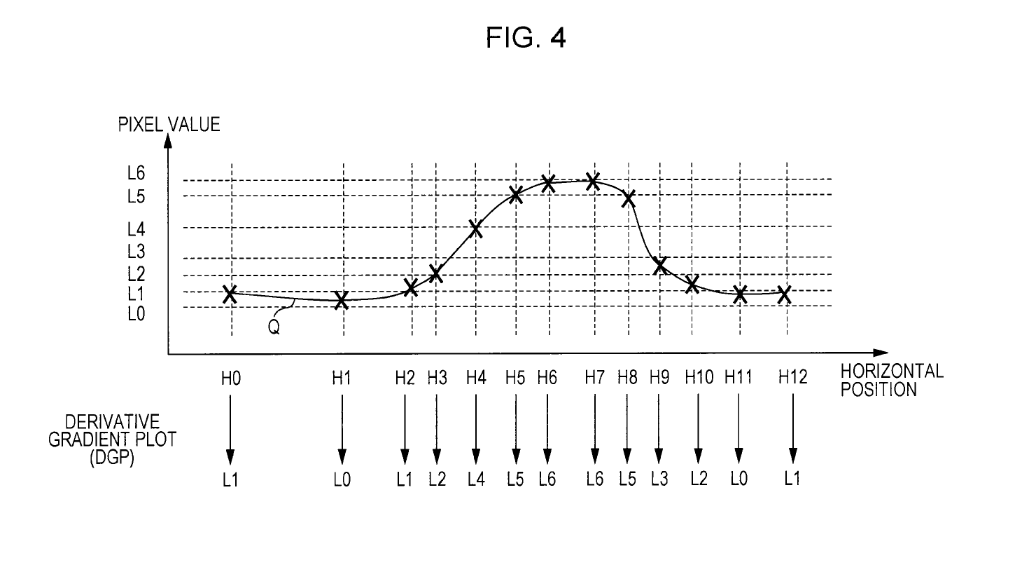

In a case where the sign of each of the gradient amounts at an interval between Lx+1−Lx and Lx−Lx−1 is changed, the correlation candidate extraction unit 201 makes the object pixel Px the correlation candidate DGP(Hx). Accordingly, the correlation candidate extraction unit 201 records (Differential Gradient Plot) the position coordinates Hx and the pixel value Lx thereof. FIG. 4 illustrates an example of the correlation candidate that is extracted at the correlation candidate extraction unit 201 and the correlation candidates of DGP(H0) to DGP(H12) are extracted. A continuous line Q illustrates a shape of change of the pixel data value of each correlation candidate.

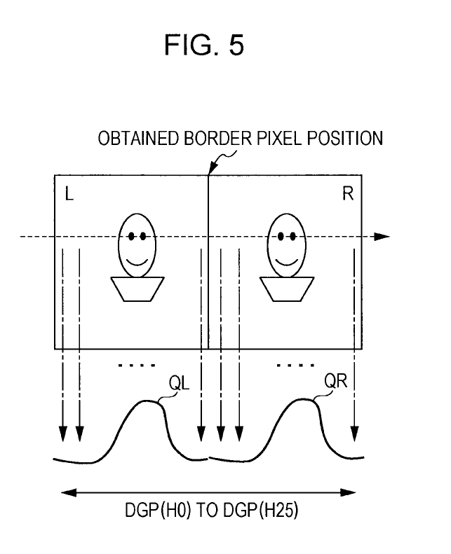

FIG. 5 illustrates an example of the correlation candidate that is extracted at the correlation candidate extraction unit 201 in a case where the image data VD is the three-dimensional image data of the side-by-side type and illustrates that for example, the correlation candidates of DGP(H0) to DGP(H25) are extracted. A continuous line QL illustrates a shape of a change of the pixel data value of the correlation candidate that is extracted at the left eye image side and a continuous line QR illustrates a shape of a change of the pixel data value of the correlation candidate that is extracted at the right eye image side. In this case, the continuous line QL and the continuous line QR have the correlation to each other.

The correlation inspection unit 202 inspects whether or not the first correlation candidate range and the second correlation candidate range having the correlation to each other in the horizontal line are present, based on the correlation candidate that is extracted at the correlation candidate extraction unit 201. The correlation inspection unit 202 performs the inspection, in other words, the correlation inspection, for example, in the order below.

First, the pixel data value of initial correlation candidate among the correlation candidates that are extracted at the correlation candidate extraction unit 201 is an initial scan•target value ST. Thus, the correlation candidates after second correlation candidate are scanned from left to right of the horizontal line and the correlation candidate of which the pixel data value is the same as the scan•target value ST is registered in a coincidence list.

Next, the correlation candidate that is registered in the coincidence list sequentially and individually moves to an accord list and the scanning process is performed. In the scanning process, the scan•target value ST is sequentially set to the pixel data value of the correlation candidates after second correlation candidate. Thus, whenever new scan•target value ST is set, it is determined whether or not the pixel data value of the correlation candidate (the object correlation candidate) next to the final correlation candidate registered in the accord list is accorded to the scan•target value ST.

In the scanning process, when it is accorded, the correlation candidate is additionally registered in the accord list. Thus, after the additional registration, it is checked whether or not the final correlation candidate is included in the correlation candidates that are registered in the accord list. When the final correlation candidate is included in the accord list, an inspection result where the first correlation candidate range and the second correlation candidate range having the correlation candidate to each other in the horizontal line are present is obtained. In this case, the second correlation candidate range is from the correlation candidate that is initially registered to the correlation candidate that is finally registered (the final correlation candidate) at the accord list and remained correlation candidates are the first correlation candidate range. In addition, at this time, the pixel position of the correlation candidate that is initially registered in the accord list is the border pixel position of the left eye image and the right eye image in the horizontal direction.

Meanwhile, in the scanning process, when it is not accorded, all correlation candidates that are registered in the accord list are erased and next correlation candidate among the correlation candidates that are registered in the coincidence list moves to the accord list so that the above described scanning process is performed. Even though the above described scanning process is performed regarding all correlation candidates that are registered in the coincidence list, it may be in a state where the final correlation candidate is not included in the accord list. At this time, the inspection result that the first correlation candidate range and the second correlation candidate range having the correlation to each other in the horizontal line are not present is obtained. Such inspection result is obtained when the image data VD is not the three-dimensional image data of the side-by-side type.

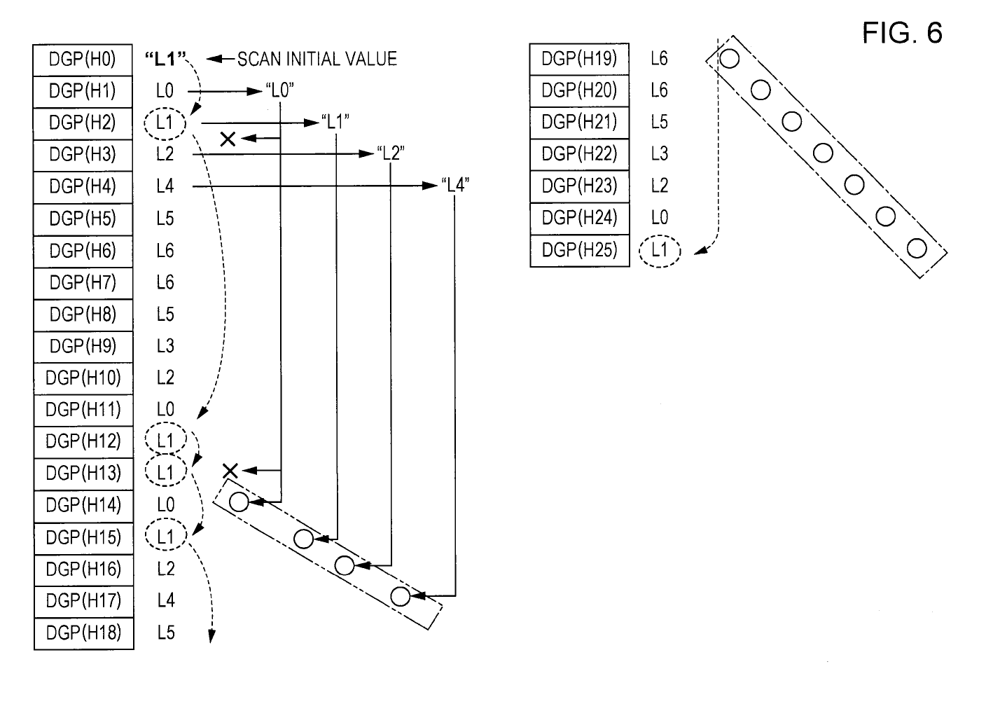

FIG. 6 illustrates a specific example of the correlation inspection at the correlation inspection unit 202. In the example, the image data VD is the three-dimensional image data of the side-by-side type and 26 correlation candidates DGP(H0) to DGP(H25) are extracted from the pixel data of the horizontal line of the image data VD.

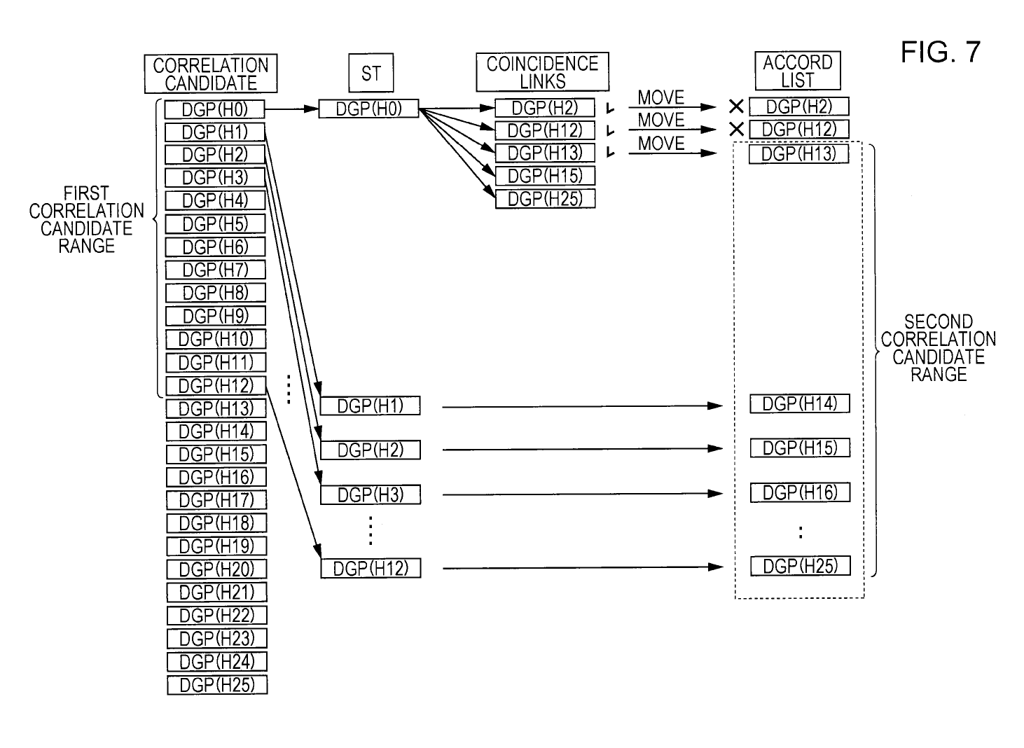

First, a pixel data value L1 of the initial correlation candidate DGP(H0) among the correlation candidates DGP(H0) to DGP(H25) is the initial scan•target value ST. Thus, the correlation candidates after second correlation candidate are scanned from left to right in the horizontal line and the correlation candidates DGP(H2), DGP(H12), DGP(H13), DGP(H15) and DGP(H25) where the pixel data value is the same as the scan•target value ST are registered at the coincidence list (see FIG. 7).

Next, initial correlation candidate DGP(H2) among the correlation candidates that are registered in the coincidence list moves to the accord list (see FIG. 7) and the scanning process is performed. In the scanning process, it is not in a state where the final correlation candidate is included in the accord list and at this time it is in a state where the pixel data value of the object correlation candidate (DGP(H3)) does not accord to the scan•target value ST=L0 (illustrated in “X” in FIG. 6). Thus, in relation to the correlation candidate DGP(H2), the correlation candidate, in other words, DGP(H2) that is registered in the accord list is erased.

Next, the second correlation candidate DGP(H12) among the correlation candidates that are registered in the coincidence list moves to the accord list (see FIG. 7) and the scanning process is performed. In the scanning process, it is not in a state where the final correlation candidate is included in the accord list and at this time it is in a state where the pixel data value of the object correlation candidate (DGP(H13)) does not accord to the scan•target value ST=L0 (illustrated in “X” in FIG. 6). Thus, in relation to the correlation candidate DGP(H12), the correlation candidate, in other words, DGP(H12) that is registered in the accord list is erased.

Next, the third correlation candidate DGP(H13) among the correlation candidates that are registered in the coincidence list moves to the accord list (see FIG. 7) and the scanning process is performed. In the scanning process, until it is in a state where the final correlation candidate is included in the accord list, it is in a state, at this time, where the pixel data values of the object correlation candidates (DGP(H14) to DGP(H25)) accords to the scan•target value ST (illustrated in “o” in FIG. 6).

Accordingly, the inspection result where the first correlation candidate range and the second correlation candidate range having the correlation to each other in the horizontal line are present is obtained. In addition, at this time, the pixel position of the correlation candidate DGP(H13) that is initially registered in the accord list is the border pixel position of the left eye image and the right eye image in the horizontal direction.

In this case, from the correlation candidate that is initially registered to the correlation candidate that is finally registered (the final correlation candidate) in the accord list, in other words, the correlation candidates DGP(H13) to DGP(H25) are the second correlation candidate range and remained correlation candidates DGP(H0) to DGP(H12) are the first correlation candidate range (see FIG. 7). In this case, in relation to the fourth and the fifth correlation candidates DGP(H15) and DGP(H25) among the correlation candidates that are registered in the coincidence list, they move to the accord list so that the scanning process is omitted.

The discriminating image format unit 203 discriminates whether the image data VD is the three-dimensional image data of the side-by-side type or the two-dimensional image data based on the inspection result of the correlation inspection unit 202. Even though it is not described above, the correlation candidate extraction unit 201 and the correlation inspection unit 202 perform the process with respect to a plurality of horizontal lines. The discriminating image format unit 203 performs the discrimination, based on statistics of the inspection result of the correlation inspection unit 202 with respect to a plurality of horizontal lines.

When the first correlation candidate range and the second correlation candidate range having the correlation to each other in the horizontal line is for example, in a certain ratio or more, the discriminating image format unit 203 discriminates that the image data VD is the three-dimensional image data of the side-by-side type. Meanwhile, with this exception, the discriminating image format unit 203 discriminates that the image data VD is the two-dimensional image data.

In addition, when the discriminating image format unit 203 discriminates that the image data VD is the three-dimensional image data of the side-by-side type, the border pixel position (the L/R border coordinate) of the left eye image and the right eye image in the horizontal direction is obtained. In this case, the discriminating image format unit 203 obtains the border pixel position in every horizontal line, based on the size ratio of the first correlation candidate range and the second correlation candidate range that are obtained at every horizontal line at the correlation inspection unit 202.

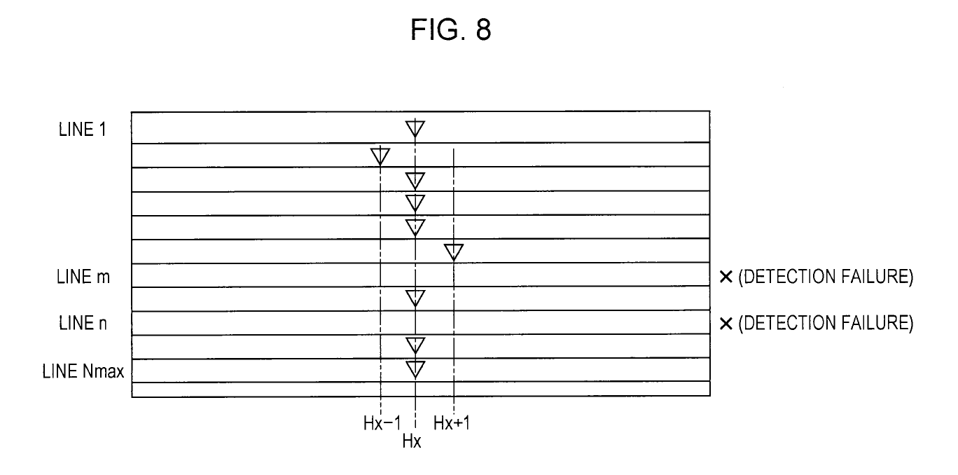

Accordingly, the discriminating image format unit 203 determines the border pixel position that is the same as a certain ratio or more among the border pixel positions obtained at each horizontal line is the final border pixel position. For example, FIG. 8 is illustrates an example of the border pixel position that are obtained at the horizontal lines of line 1 to line Nmax. In the case of the example, the ratio of the border pixel position Hx is a ratio or more so that the border pixel position Hx is the final border pixel position. In addition, in FIG. 8, the correlation inspection unit 202 obtains the inspection result that for example, the first correlation candidate range and the second correlation candidate range having the correlation to each other are not present in line m and line n, and the horizontal line that may not obtain the border pixel position is illustrated.

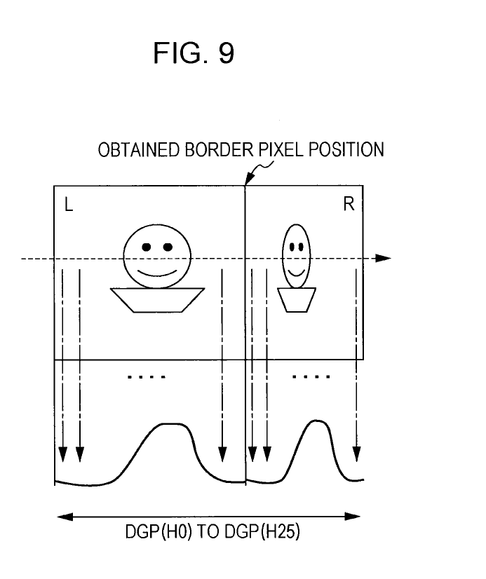

The border pixel position (the L/R border coordinate) that is obtained by the discriminating image format unit 203 appropriately illustrates the border position of the left eye image and the right eye image in the horizontal direction. For example, when the horizontal sizes of the left eye image and the right eye image are the same size, as shown in FIG. 5, the border pixel position to be obtained illustrates the center position of the horizontal size (H_size). In addition, for example, as shown in FIG. 9, even though when the horizontal sizes of the left eye image and the right eye image are different, the border pixel position to be obtained accurately illustrates the border position of the left eye image and the right eye image in the horizontal direction.

Here, the size of the first correlation candidate range is obtained by subtracting the horizontal position coordinates of the initial correlation candidate from the horizontal position coordinates of the final correlation candidate. Similarly, the size of the second correlation candidate range is obtained by subtracting the horizontal position coordinates of the initial correlation candidate from the horizontal position coordinates of the final correlation candidate. For example, in the examples in FIGS. 6 and 7, the size of the first correlation candidate range is (H12-H0) and the size of the second correlation candidate range is (H25-H13).

The horizontal size (H_size) is divided in the size ratio of the first correlation candidate range and the second correlation candidate range so that the horizontal size A of the left eye image and the horizontal size B of the right eye image may be obtained. Thus, the border pixel position (the L/R border coordinate) of the left eye image and the right eye image in the horizontal direction may be obtained (see FIGS. 2A to 2F).

An operation of the image format discrimination device 118 shown in FIG. 3 will be briefly described. The image data VD are supplied to the correlation candidate extraction unit 201. The correlation candidate extraction unit 201 obtains the gradient amount of each pixel position and extracts as the correlation candidate, the pixel of the position where the sign of the gradient amount is changed based on the pixel data of the horizontal line of the image data VD.

The correlation candidate that is extracted at the correlation candidate extraction unit 201 is supplied to the correlation inspection unit 202. The correlation inspection unit 202 inspects whether or not the first correlation candidate range and the second correlation candidate range having the correlation to each other in the horizontal line are present, based on the correlation candidate that is extracted at the correlation candidate extraction unit 201. The inspection result is supplied to the discriminating image format unit 203. In this case, when the inspection result is obtained where the first correlation candidate range and the second correlation candidate range having the correlation to each other in the horizontal line are present, the information of the first correlation candidate range and the second correlation candidate range also are supplied to the discriminating image format unit 203.

The discriminating image format unit 203, discriminates whether the image data VD is the three-dimensional image data of the side-by-side type or the two-dimensional image data, based on the inspection result of the correlation inspection unit 202. In this case, it is identified, based on the statistics of the inspection result of the correlation inspection unit 202 with respect to a plurality of horizontal lines.

When the first correlation candidate range and the second correlation candidate range having the correlation to each other in the horizontal line is for example, in a certain ratio or more, the discriminating image format unit 203 discriminates that the image data VD is the three-dimensional image data of the side-by-side type. Meanwhile, with this exception, the discriminating image format unit 203 discriminates that the image data VD is the two-dimensional image data.

In addition, when the discriminating image format unit 203 discriminates that the image data VD is the three-dimensional image data of the side-by-side type, furthermore, the border pixel position (the L/R border coordinate) of the left eye image and the right eye image in the horizontal direction are obtained. In this case, the discriminating image format unit 203 obtains the border pixel position for every horizontal line, based on the size ratio of the first correlation candidate range and the second correlation candidate range that are obtained at every horizontal line at the correlation inspection unit 202. Thus, the discriminating image format unit 203 determines that the border pixel position that is the same as a certain ratio or more among the border pixel position obtained at each horizontal line is the final border pixel position.

The discrimination information DI indicating the discrimination result is output from the discriminating image format unit 203. The discrimination information DI also includes the information where the image data VD is the three-dimensional image data of the side-by-side type in a case where the border pixel position of the left eye image and the right eye image in the horizontal direction is obtained. The discrimination information DI, as described above, is transmitted to the CPU 101 of the television receiver 100.

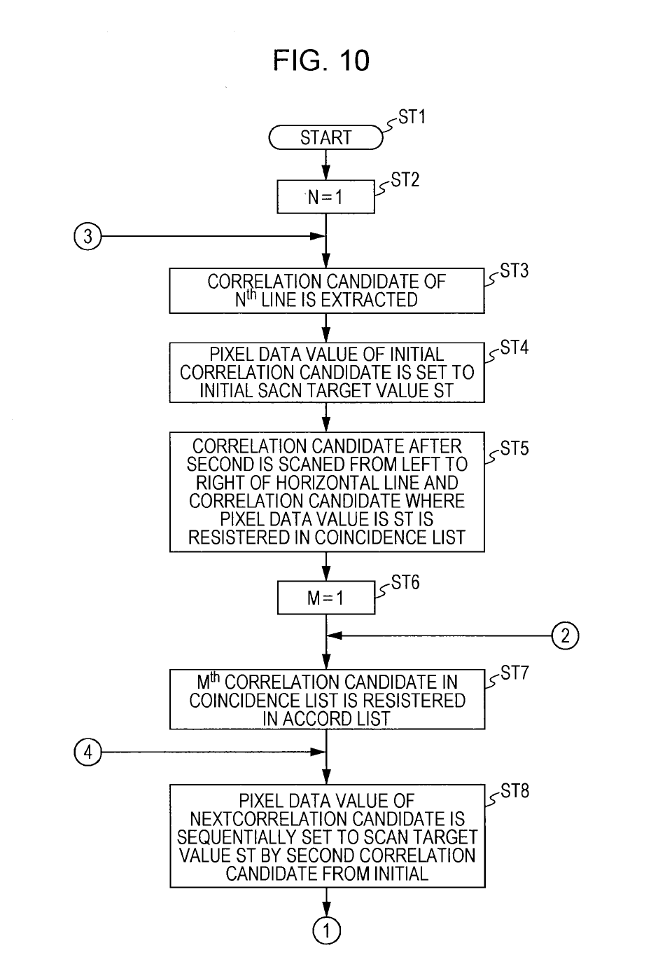

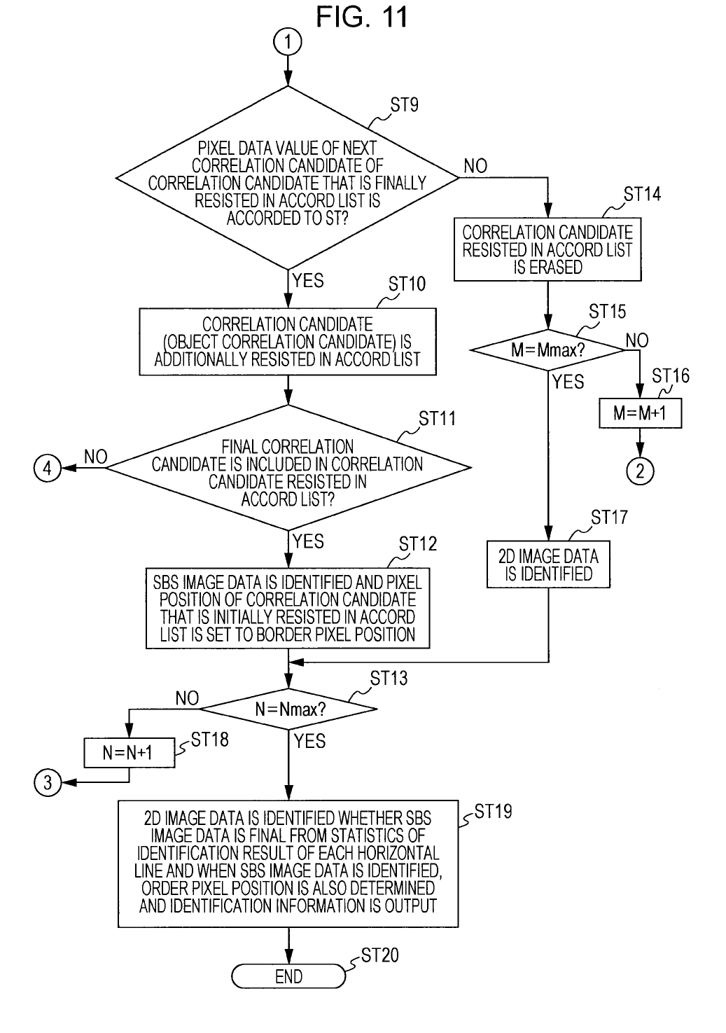

Flowcharts of FIGS. 10 and 11 illustrate an example of process sequence of the image format discrimination device 118. The image format discrimination device 118 performs the process sequence for example, in every frame.

The image format discrimination device 118 starts the process in step ST1, N=1 is set in step ST2 and then the process moves to step ST3. In step ST3, the image format discrimination device 118 obtains the gradient amount of each pixel position and extracts as the correlation candidate, the pixel of the position where the sign of the gradient amount is changed, based on the pixel data of the input image data VD of the N^{th} line.

Next, in step ST4, the image format discrimination device 118 allows the pixel data value of initial correlation candidate to be the initial scan•target value ST. Thus, the image format discrimination device 118 scans the correlation candidates after the second correlation candidate from left to right in the horizontal line and registers the correlation candidate where the pixel data value is the scan•target value ST to the coincidence list.

Next, in step ST6, the image format discrimination device 118 set M=1 and then the process moves to step ST7. In step ST7, the image format discrimination device 118 registers the correlation candidate of M^{th} to the accord list among the correlation candidates registered in the coincidence list.

Next, in step ST8, the image format discrimination device 118 allows the pixel data value of next correlation candidate (first is the second correlation candidate) to be the scan•target value ST. Thus, in step ST9, the image format discrimination device 118 determines that the pixel data value of the next correlation candidate (the object correlation candidate) of the correlation candidate that is finally registered in the accord list is the same as the scan•target value ST, at this time.

When the condition in step ST9 is satisfied, in step ST10, the image format discrimination device 118 additionally registers the correlation candidate (the object correlation candidate) to the accord list. In step ST11, the image format discrimination device 118 determines that the final correlation candidate is included in the correlation candidates registered in the accord list. In step ST11, when the condition is not satisfied, the image format discrimination device 118 returns to the process of step ST8 and the scanning process is continued.

The condition in step ST11 is satisfied, in step ST12, the image format discrimination device 118 discriminates that the image data VD is the three-dimensional (3D) image data VD of the side-by-side type. In addition, in step ST12, the pixel position of the correlation candidate that is initially registered in the accord list is the border pixel position (the L/R border coordinate) of the left eye image and the right eye image in the horizontal direction. After the process of step ST12, the image format discrimination device 118 moves to the process of step ST13.

When above described condition in step ST9 is not satisfied, in step ST14, the image format discrimination device 118 erases the correlation candidate that is registered in the accord list. Thus, in step ST15, the image format discrimination device 118 discriminates whether or not M=Mmax. Here, Mmax illustrates the number of the correlation candidates that are registered in the coincidence list.

When it is not M=Mmax, in step ST16, the image format discrimination device 118 increases M as much as 1 and returns to the process of step ST7, and then the scanning process with respect to the next correlation candidate that is registered in the coincidence list starts. Meanwhile, when it is M=Mmax, in step ST17, the image format discrimination device 118 discriminates that the image data VD is the two-dimensional (2D) image data and then moves to the process of step ST13. In step ST13, the image format discrimination device 118 determines whether or not N=Nmax. Here, Nmax illustrates the number of the inspection lines.

When it is not N=Nmax, the image format discrimination device 118 realizes that the horizontal line to be inspected is still present. At this time, in step ST18, the image format discrimination device 118 increases N as much as 1, returns the process of step ST3 and performs the process of the next horizontal line. Meanwhile, when it is N=Nmax, the image format discrimination device 118 moves to the process of step ST19.

In step ST19, the image format discrimination device 118 finally discriminates whether the image data VD is the three-dimensional image data of the side-by-side type or the two-dimensional image data from the statistics of the discrimination result of each horizontal line. In this case, when it is identified that the three-dimensional image data of the side-by-side type is present in the horizontal line of a ratio or more, the image format discrimination device 118 discriminates the three-dimensional image data of the side-by-side type and with this exception, discriminates the two-dimensional image data.

In addition, in step ST19, the image format discrimination device 118 also determines the border pixel position of the left eye image and the right eye image in the horizontal direction. In this case, the image format discrimination device 118 determines the border pixel position that is the same as a ratio or more among the border pixel position obtained at each horizontal line is the final border pixel position. Thus, in step ST19, the image format discrimination device 118 outputs the discrimination information DI. After the process of step ST19, the image format discrimination device 118 finishes the process in step ST20.

As described above, the image format discrimination device 118 shown in FIG. 3, extracts as the correlation candidate, the pixel of the position where the sign of the gradient amount of each pixel position in the horizontal line is changed. Thus, the image format discrimination device 118 discriminates whether or not the input image data are the three-dimensional image data of the side-by-side type according that whether or not the first correlation candidate range and the second correlation candidate range having the correlation to each other in the horizontal line is present. Thus, the discrimination of the three-dimensional image data of the side-by-side type may be favorably performed.

In addition, when the image format discrimination device 118 shown in FIG. 3, discriminates that the image data of the side-by-side type is present, the border pixel position of the left eye image and the right eye image in the horizontal direction is obtained. Thus, even in a case where for example, resolutions in the horizontal direction of the left eye image data and right eye image data are different, the cut out of the left eye image data or the right eye image data from the image data of the side-by-side type may be appropriately performed.

In addition, in the image format discrimination device 118 shown in FIG. 3, the discriminating image format unit 203 determines whether or not the input image data are the three-dimensional image data of the side-by-side type, based on the inspection result of a plurality of horizontal lines at the correlation inspection unit 202. Thus, discrimination precision of whether or not the image data of the side-by-side type is present may be increased. In addition, precision of the border pixel position of the left eye image and the right eye image in the horizontal direction may also be increased.

### 2. Second Embodiment

[Configuration Example of Television Receiver (2DTV)]

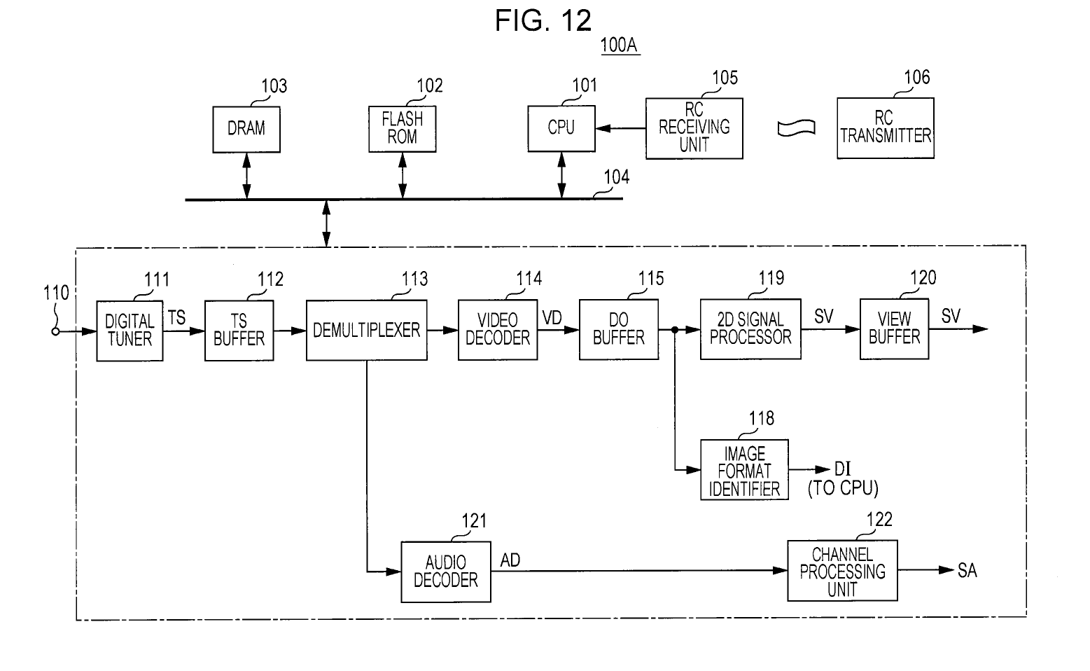

FIG. 12 illustrates a configuration example of a television receiver 100A as a second embodiment of the present disclosure. The television receiver 100A is a television receiver (2DTV) that may be only 2D display. In FIG. 12, portions corresponding to those in FIG. 1 are given similar reference numbers thereof, thus not specifically described in here.

The image format discrimination device 118 is configured similar to the image format discrimination device 118 of the above described television receiver 100. In other words, the image format discrimination device 118 discriminates the image format of the image data VD that is accumulated in the DO buffer 115. In other words, the image format discrimination device 118 discriminates whether the image data VD is the three-dimensional image data of the side-by-side type or the two-dimensional image data, based on the image data VD. In addition, when the image data VD is identified as the three-dimensional image data of the side-by-side type, the image format discrimination device 118 furthermore, obtains the border pixel position (the L/R border coordinate) of the left eye image and the right eye image in the horizontal direction.

The image format discrimination device 118 transmits the discrimination information DI that indicates the discrimination result of the image format to the CPU 101. In a case where above described image data VD is the three-dimensional image data of the side-by-side type and the border pixel position of the left eye image and the right eye image in the horizontal direction is obtained, the information is also included in the discrimination information DI. The CPU 101 realizes the image format or the like of the image data VD and controls such that a 2D signal process unit 119 operates according to the image format, based on the discrimination information DI.

In the television receiver 100A, the above described portions of the 3D signal processing unit 116 and view buffers 117L and 117R in the television receiver 100 is configured by the 2D signal process unit 119 and a view buffer 120. With this exception, detailed description is omitted, however the television receiver 100A is configured similar to the television receiver 100 shown in FIG. 1.

When the image data VD that is accumulated in the DO buffer 115 is the three-dimensional image data of the side-by-side type, the 2D signal process unit 119 performs the process described below. In other words, the 2D signal process unit 119 cuts out the left eye image data or the right eye image data from the image data VD, performs scaling process in the horizontal direction and generates the image data SV for two-dimensional display. In addition, when the image data VD that is accumulated in the DO buffer 115 is the two-dimensional image data, the 2D signal process unit 119 performs the process described below. In other words, the 2D signal process unit 119 outputs as the image data SV for two-dimensional display, the image data VD as is.

The view buffer 120 temporarily accumulates the image data SV for two-dimensional display that is obtained by the 2D signal process unit 119 and outputs to the image output unit such as display.

Operation of the television receiver 100A shown in FIG. 12 will be briefly described. The television broadcasting signal that is input to the antenna terminal 110 is supplied to the digital tuner 111. In the digital tuner 111, the television broadcasting signal is processed and a predetermined transport stream TS corresponding to the channel that is selected by the user is output. The transport stream TS is temporarily accumulated in the TS buffer 112.

The demultiplexer 113 extracts each elementary stream of the video and audio from the transport stream TS that is temporarily accumulated in the TS buffer 112. The video elementary stream that is extracted in the demultiplexer 113 is supplied to the video decoder 114.

The video decoder 114 performs the decoding process with respect to the encoded image data included in video elementary stream that is extracted in the demultiplexer 113 so that the image data (the two-dimensional image data or the three-dimensional image data of the side-by-side type) VD is obtained. The image data VD is temporarily accumulated in the DO buffer 115.

The image format discrimination device 118 discriminates whether the image data VD is the three-dimensional image data of the side-by-side type or the two-dimensional image data, based on the image data VD. In addition, when it determines the three-dimensional image data of the side-by-side type, furthermore, the image format discrimination device 118 obtains the border pixel position of the left eye image and the right eye image in the horizontal direction.

The discrimination information DI that indicates the discrimination result of the image format is transmitted to the CPU 101 from the image format discrimination device 118. The CPU 101 realizes the image format of the image data VD that is obtained by the video decoder 114 and accumulated in the DO buffer 115, based on the discrimination information DI. In addition, in a case where the image data VD is the three-dimensional image data of the side-by-side type, the CPU 101 realizes the border pixel position of the left eye image and the right eye image in the horizontal direction. Thus, the CPU 101 controls such that the 2D signal process unit 119 or the like operates according to the image format.

As shown in FIG. 2A, when the image data VD is the three-dimensional image data of the side-by-side type, the image format discrimination device 118 discriminates that the image data VD is the three-dimensional image data of the side-by-side type. Thus, the image format discrimination device 118 also obtains the border pixel position (the L/R border coordinate) of the left eye image and the right eye image in the horizontal direction.

At this time, the 2D signal process unit 119 performs the process described below. In other words, the 2D signal process unit 119 cuts out image data one of the left eye image data and the right eye image data illustrating FIG. 2B from the image data VD accumulated in the DO buffer 115. In this case, for example, the image data where the horizontal size is large in the left eye image data and the right eye image data, in other words, left eye image data in the example of FIGS. 2A to 2F, is cut out. The cut out process of the image data is performed, based on the border pixel position of the left eye image and the right eye image in the horizontal direction.

Thus, the 2D signal process unit 119 performs the scaling process of the horizontal direction with respect to for example, left eye image data that is cut out and as shown in FIG. 2D, the image data SV for two-dimensional display is generated. Here, in a case where the horizontal size of the left eye image with respect to the horizontal size H_size of the entire image is “A”, the scaling process where it is H_size/A times in the horizontal direction with respect to the left eye image data is performed.

The image data SV for two-dimensional display that is generated in the 2D signal process unit 119 is supplied to the image output unit such as the display through the view buffer 120. The two-dimensional image is displayed in the image output unit, based on the image data SV for two-dimensional display.

In addition, as shown in FIG. 2E, when the image data VD is the two-dimensional image data, the image format discrimination device 118 discriminates that the image data VD is the two-dimensional image data. At this time, the 2D signal process unit 119 performs the process described below. In other words, as shown in FIG. 2F, the 2D signal process unit 119 outputs as the image data SV for two-dimensional display, the image data VD as is, that is accumulated in the DO buffer 115. The image data SV for two-dimensional display is supplied to the image output unit such as the display through the view buffer 120. The two-dimensional image is displayed on the image output unit, based on the image data SV for two-dimensional display.

In addition, the audio elementary stream that is extracted in the demultiplexer 113 is supplied to the audio decoder 121. The audio decoder 121 performs the decoding process with respect to the encoded voice data included in the audio elementary stream so that the voice data AD that is decoded is obtained. The voice data AD is supplied to the channel processing unit 122. The channel processing unit 122 generates the voice data SA of each channel to realize for example, 5.1 channel surround sound or the like with respect to the voice data. The voice data SA is supplied to the voice output unit such as a speaker and the voice corresponding to the display image is output.

As described above, in the television receiver (2DTV) 100A shown in FIG. 12, the discrimination information DI of the image format discrimination device 118 is used so that good image display is performed. In other words, when the received image data VD is the three-dimensional image data of the side-by-side type, the cut out of the left eye image data or the right eye image data are properly performed so that the display of the two-dimensional image is favorably performed. Furthermore, when the received image data VD is the two-dimensional image data, the display of the two-dimensional image is favorably performed by the two-dimensional image data.

### 3. Modified Example

In addition, in the above described embodiment, when the image data VD is the three-dimensional image data of the side-by-side type, the image format discrimination device 118 calculates the border pixel position (the L/R border coordinate) of the left eye image and the right eye image in the horizontal direction. However, in the three-dimensional image data of the side-by-side type as the image data VD, the calculation is not necessary if it is confirmed that the resolutions in the horizontal direction of the left eye image data and right eye image data are same.

In addition, in the above described embodiments, the television receivers 100 and 100A having the image format discrimination device 118 are exemplified. However, it goes without saying that the image format discrimination device 118 of the present disclosure may also be similarly applied to other electronic devices such as a recorder and a player where the discrimination of the image format of the image data is demanded.

In addition, in the above described embodiments, the discrimination process of the image format of the image format discrimination device 118 may be performed not only in hardware but also in software. In a case where the process is performed in software, a program that records the process sequence is installed and performed in a memory inside the computer that is assembled in a dedicated hardware. Otherwise, the program is installed and performed in a general-purposed computer that may perform various processes. In this case, the computer functions as each of function blocks of the image format discrimination device 118.

In addition, the present disclosure may have configurations described below.

(1) An image format discrimination device includes: that a correlation candidate extraction unit obtains a gradient amount of each pixel position based on pixel data of a horizontal line of input image data, and extracts, as a correlation candidate, a pixel of a position where a sign of the gradient amount is changed; a correlation inspection unit inspects whether or not a first correlation candidate range and a second correlation candidate range having correlation to each other in the horizontal line are present, based on the correlation candidate that is extracted by the correlation candidate extraction unit; and a discriminating image format unit discriminates whether or not the input image data are three-dimensional image data of a side-by-side type, based on the inspection result of the correlation inspection unit.

(2) In the image format discrimination device according to the above described (1), the discriminating image format unit obtains a border pixel position of a left eye image and a right eye image in the horizontal direction, based on a size ratio of the first correlation candidate range and the second correlation candidate range when it is discriminated that the input image data are the image data of the side-by-side type.

(3) In the image format discrimination device according to the above described (1) or (2), the discriminating image format unit discriminates whether or not the input image data are the three-dimensional image data of the side-by-side type, based on the inspection result of a plurality of horizontal lines in the correlation inspection unit.

(4) In the image format discrimination device according to any one of above described (1) to (3), the correlation candidate extraction unit obtains a differential of pixel data values between adjacent pixels as the gradient amount of each pixel position.

(5) An method of discriminating an image format includes: obtaining a gradient amount of each pixel position, based on pixel data of the horizontal line of input image data and extracting a pixel of a position where a sign of the gradient amount is changed as a correlation candidate; inspecting whether or not a first correlation candidate range and a second correlation candidate range having correlation to each other in the horizontal line, based on the correlation candidate that is extracted by the correlation candidate extracting; and discriminating whether or not the input image data are three-dimensional image data of a side-by-side type, based on the inspection result of the correlation inspecting.

(6) An image reproducing device includes: an image format discrimination device that discriminates whether or not input image data are three-dimensional image data of a side-by-side type, based on the input image data; and an image data processing unit that processes the input image data based on the discrimination result of the image format discrimination device and obtains an image data for display, wherein the image format discrimination device includes, a correlation candidate extraction unit that obtains a gradient amount of each pixel position, based on pixel data of a horizontal line of the input image data and extracts, as a correlation candidate, a pixel of a position where a sign of the gradient amount is changed; a correlation inspection unit that inspects whether or not a first correlation candidate range and a second correlation candidate range having the correlation to each other in the horizontal line, based on the correlation candidate that is extracted by the correlation candidate extraction unit; and a discriminating image format unit that discriminates whether or not the input image data are the three-dimensional image data of the side-by-side type, based on the inspection result of the correlation inspection unit.

(7) An image reproducing device includes: an image format discrimination device that discriminates whether or not input image data are three-dimensional image data of a side-by-side type, based on the input image data and, when it is discriminated that the input data are the three-dimensional image data of the side-by-side type, obtains a border pixel position of a left eye image and a right eye image in a horizontal direction; and an image data processing unit cuts out left eye image data and right eye image data, based on the border pixel position that is obtained by the image format discrimination device from the input image data, performs a scaling process in the horizontal direction and generates image data for display of the left eye and the right eye when the image format discrimination device discriminates that the input data are the three-dimensional image data of the side-by-side type, wherein the image format discrimination device includes a correlation candidate extraction unit that obtains a gradient amount of each pixel position, based on pixel data of a horizontal line of the input image data and extracts as the correlation candidate, a pixel of a position where a sign of the gradient amount is changed; a correlation inspection unit that inspects whether or not a first correlation candidate range and a second correlation candidate range having the correlation to each other in the horizontal line are present, based on the correlation candidate that is extracted by the correlation candidate extraction unit; and a discriminating image format unit that discriminates whether or not the input image data are three-dimensional image data of the side-by-side type, based on the inspection result of the correlation inspection unit and, when it is discriminated that the input data are the image data of the side-by-side type, obtains the border pixel position of the left eye image and the right eye image in the horizontal direction, based on size ratio of the first correlation candidate range and the second correlation candidate range.

(8) In the image reproducing device according to the above described (7), the image data processing unit cuts out the left eye image data and the right eye image data, performs scaling process in the horizontal direction and generates image data for display of the left eye and the right eye, when the discriminating image format unit discriminates that the input data are the three-dimensional image data of the side-by-side type in the three-dimensional display mode, based on the border pixel position that is obtained by the discriminating image format unit from the input image data, and wherein the image data processing unit cuts out the left eye image data and the right eye image data, performs scaling process in the horizontal direction and generates image data for two-dimensional display, when the discriminating image format unit discriminates that the input data are the three-dimensional image data of the side-by-side type in the two-dimensional display mode, based on the border pixel position that is obtained by the discriminating image format unit from the input image data.

(9) An image reproducing device includes: that an image format discrimination device discriminates whether or not input image data are three-dimensional image data of a side-by-side type, based on the input image data and, when it is discriminated that the input data are the three-dimensional image data of the side-by-side type, obtains a border pixel position of a left eye image and a right eye image in a horizontal direction; and an image data processing unit cuts out left eye image data and right eye image data, based on the border pixel position that is obtained by the discriminating image format unit from the input image data, performs a scaling process in the horizontal direction and generates image data for two-dimensional display, when the image format discrimination device discriminates that the input data are the three-dimensional image data of the side-by-side type, wherein the image format discrimination device includes, a correlation candidate extraction unit that obtains a gradient amount of each pixel position, based on pixel data of a horizontal line of the input image data and extracts as the correlation candidate, a pixel of a position where a sign of the gradient amount is changed, a correlation inspection unit that inspects whether or not a first correlation candidate range and a second correlation candidate range having the correlation to each other in the horizontal line are present, based on the correlation candidate that is extracted by the correlation candidate extraction unit; and a discriminating image format unit that discriminates whether or not the input image data are the three-dimensional image data of the side-by-side type, based on the inspection result of the correlation inspection unit and, when it is discriminated that the input data are the image data of the side-by-side type, obtains the border pixel position of the left eye image and the right eye image in the horizontal direction, based on size ratio of the first correlation candidate range and the second correlation candidate range.

(10) An electronic apparatus includes: an image format discrimination device discriminates an image format of input image data, wherein the image format discrimination device includes, a correlation candidate extraction unit that obtains a gradient amount of each pixel position, based on pixel data of a horizontal line of the input image data and extracts as a correlation candidate, a pixel of a position wherein a sign of the gradient amount is changed; a correlation inspection unit that inspects whether or not a first correlation candidate range and a second correlation candidate range having the correlation to each other in the horizontal line are present, based on the correlation candidate that is extracted by the correlation candidate extraction unit; and a discriminating image format unit that discriminates whether or not the input image data are three-dimensional image data of a side-by-side type, based on the inspection result of the correlation inspection unit.

The present disclosure contains subject matter related to that disclosed in Japanese Priority Patent Application JP 2011-137854 filed in the Japan Patent Office on Jun. 21, 2011, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An image format discrimination device comprising:
a correlation candidate extraction unit that obtains a gradient amount of each pixel position based on pixel data of a horizontal line of input image data, and extracts, as a correlation candidate, a pixel of a position where a sign of the gradient amount is changed;
a correlation inspection unit that inspects whether or not a first correlation candidate range and a second correlation candidate range having correlation to each other in the horizontal line are present, based on the correlation candidate that is extracted by the correlation candidate extraction unit; and
an discriminating image format unit that discriminates whether or not the input image data are three-dimensional image data of a side-by-side type, based on the inspection result of the correlation inspection unit.

2. The image format discrimination device according to claim 1,
wherein the discriminating image format unit obtains a border pixel position of a left eye image and a right eye image in the horizontal direction, based on a size ratio of the first correlation candidate range and the second correlation candidate range, when it is discriminated that the input image data are the image data of the side-by-side type.

3. The image format discrimination device according to claim 1,
wherein the discriminating image format unit discriminates whether or not the input image data are the three-dimensional image data of the side-by-side type, based on the inspection result of a plurality of horizontal lines in the correlation inspection unit.

4. The image format discrimination device according to claim 1,
wherein the correlation candidate extraction unit obtains a differential of pixel data values between adjacent pixels as the gradient amount of each pixel position.

5. A method of discriminating an image format comprising:
obtaining a gradient amount of each pixel position, based on pixel data of a horizontal line of input image data and extracting a pixel of a position where a sign of the gradient amount is changed as a correlation candidate;
inspecting whether or not a first correlation candidate range and a second correlation candidate range having correlation to each other in the horizontal line, based on the correlation candidate that is extracted by the correlation candidate extracting; and
discriminating whether or not the input image data are three-dimensional image data of a side-by-side type, based on the inspection result of the correlation inspecting.

6. An image reproducing device comprising:
an image format discrimination device that discriminates whether or not input image data are three-dimensional image data of a side-by-side type, based on the input image data; and
an image data processing unit that processes the input image data based on the discrimination result of the image format discrimination device and obtains an image data for display,
wherein the image format discrimination device includes,
a correlation candidate extraction unit that obtains a gradient amount of each pixel position, based on pixel data of a horizontal line of the input image data and extracts, as a correlation candidate, a pixel of a position where a sign of the gradient amount is changed;
a correlation inspection unit that inspects whether or not a first correlation candidate range and a second correlation candidate range having the correlation to each other in the horizontal line, based on the correlation candidate that is extracted by the correlation candidate extraction unit; and
an discriminating image format unit that discriminates whether or not the input image data are the three-dimensional image data of the side-by-side type, based on the inspection result of the correlation inspection unit.

7. An image reproducing device comprising:
an image format discrimination device that discriminates whether or not input image data are three-dimensional image data of a side-by-side type, based on the input image data and, when it is discriminated that the input data are the three-dimensional image data of the side-by-side type, obtains a border pixel position of a left eye image and a right eye image in a horizontal direction; and
an image data processing unit that cuts out left eye image data and right eye image data, based on the border pixel position that is obtained by the image format discrimination device from the input image data, performs a scaling process in the horizontal direction and generates image data for display of the left eye and the right eye when the image format discrimination device discriminates that the input data are the three-dimensional image data of the side-by-side type,
wherein the image format discrimination device includes
a correlation candidate extraction unit that obtains a gradient amount of each pixel position, based on pixel data of a horizontal line of the input image data and extracts as the correlation candidate, a pixel of a position where a sign of the gradient amount is changed;
a correlation inspection unit that inspects whether or not a first correlation candidate range and a second correlation candidate range having the correlation to each other in the horizontal line are present, based on the correlation candidate that is extracted by the correlation candidate extraction unit; and
an discriminating image format unit that discriminates whether or not the input image data are three-dimensional image data of the side-by-side type, based on the inspection result of the correlation inspection unit and, when it is discriminated that the input data are the image data of the side-by-side type, obtains the border pixel position of the left eye image and the right eye image in the horizontal direction, based on size ratio of the first correlation candidate range and the second correlation candidate range.

8. The image reproducing device according to claim 7,
wherein the image data processing unit cuts out the left eye image data and the right eye image data, performs scaling process in the horizontal direction and generates image data for display of the left eye and the right eye, when the discriminating image format unit discriminates that the input data are the three-dimensional image data of the side-by-side type in the three-dimensional display mode, based on the border pixel position that is obtained by the discriminating image format unit from the input image data, and
wherein the image data processing unit cuts out the left eye image data and the right eye image data, performs scaling process in the horizontal direction and generates image data for two-dimensional display, when the discriminating image format unit discriminates that the input data are the three-dimensional image data of the side-by-side type in the two-dimensional display mode, based on the border pixel position that is obtained by the discriminating image format unit from the input image data.

9. An image reproducing device comprising:
an image format discrimination device that discriminates whether or not input image data are three-dimensional image data of a side-by-side type, based on the input image data and, when it is discriminated that the input data are the three-dimensional image data of the side-by-side type, obtains a border pixel position of a left eye image and a right eye image in a horizontal direction; and
an image data processing unit that cuts out left eye image data and right eye image data, based on the border pixel position that is obtained by the discriminating image format unit from the input image data, performs a scaling process in the horizontal direction and generates image data for two-dimensional display, when the image format discrimination device discriminates that the input data are the three-dimensional image data of the side-by-side type,
wherein the image format discrimination device includes,
a correlation candidate extraction unit that obtains a gradient amount of each pixel position, based on pixel data of a horizontal line of the input image data and extracts as the correlation candidate, a pixel of a position where a sign of the gradient amount is changed,
a correlation inspection unit that inspects whether or not a first correlation candidate range and a second correlation candidate range having the correlation to each other in the horizontal line are present, based on the correlation candidate that is extracted by the correlation candidate extraction unit; and
an discriminating image format unit that discriminates whether or not the input image data are the three-dimensional image data of the side-by-side type, based on the inspection result of the correlation inspection unit and, when it is discriminated that the input data are the image data of the side-by-side type, obtains the border pixel position of the left eye image and the right eye image in the horizontal direction, based on size ratio of the first correlation candidate range and the second correlation candidate range.

10. An electronic apparatus comprising:
an image format discrimination device that discriminates an image format of input image data,
wherein the image format discrimination device includes,
a correlation candidate extraction unit that obtains a gradient amount of each pixel position, based on pixel data of a horizontal line of the input image data and extracts as a correlation candidate, a pixel of a position where a sign of the gradient amount is changed;
a correlation inspection unit that inspects whether or not a first correlation candidate range and a second correlation candidate range having the correlation to each other in the horizontal line are present, based on the correlation candidate that is extracted by the correlation candidate extraction unit; and
a discriminating image format unit that discriminates whether or not the input image data are three-dimensional image data of a side-by-side type, based on the inspection result of the correlation inspection unit.
